(19) United States
(12) Patent Application Publication
(10) Pub. No.: US 2024/0243629 A1
(43) Pub. Date: Jul. 18, 2024

(54) AIR DUCT ASSEMBLY FOR ROTOR, ASSOCIATED ROTOR AND ELECTRIC MACHINE

(71) Applicant: ABB SCHWEIZ AG, Baden (CH)

(72) Inventors: Pei Yan, Shanghai (CN); Weimin Li, Shanghai (CN)

(21) Appl. No.: 18/561,724

(22) PCT Filed: Jun. 21, 2021
(86) PCT No.: PCT/CN2021/101298

§ 371 Date: Nov. 16, 2023

(51) Int. Cl. H02K 1/32

(52) U.S. Cl. CPC H02K 1/32

(57) ABSTRACT

An air duct assembly for a rotor of an electric machine and associated rotor and electric machine. The air duct assembly includes a base plate arranged between core laminations of the rotor, where the base plate has ventilation holes axially aligned with inlet channels of the rotor respectively; and a plurality of airflow guides axially protruding from a radial outer portion of an end surface of the base plate relative to the ventilation hole. The plurality of airflow guides includes a plurality of first guiding members extending radially; and a plurality of second guiding members arranged between the first guiding member and the ventilation holes and radially spaced apart from the first guiding member by a predetermined distance.

### FIELD

Embodiments of the present disclosure generally relate to an electric machine, and more specifically, to an air duct assembly for a rotor of an electric machine.

### BACKGROUND

In electrical engineering, electric machine is a general term for machines using electromagnetic forces, such as electric motors, electric generators, and others. They are electromechanical energy converters: an electric motor converts electricity to mechanical power while an electric generator converts mechanical power to electricity. The moving parts in a machine can be rotating (rotating machines) or linear (linear machines).

The two main parts of an electric machine can be described in either mechanical or electrical terms. In mechanical terms, the rotor is the rotating part, and the stator is the stationary part of an electric machine. In electrical terms, the armature is the power-producing component and the field is the magnetic field component of an electric machine. The armature can be on either the rotor or the stator. The magnetic field can be provided by either electromagnets or permanent magnets mounted on either the rotor or the stator.

For some electric machines, the rotor has a plurality of air ducts arranged between core laminations of the rotor to provide a path for airflow, to thereby achieve the purpose of cooling the rotor.

### SUMMARY

Embodiments of the present disclosure provide an air duct assembly for a rotor of an electric machine and associated rotor and electric machine.

In a first aspect, an air duct assembly for a rotor of an electric machine is provided. The air duct assembly comprises a base plate arranged between core laminations of the rotor and comprising ventilation holes axially aligned with inlet channels of the rotor respectively; and a plurality of airflow guides axially protruding from a radial outer portion of an end surface of the base plate relative to the ventilation hole, the plurality of airflow guides comprising a plurality of first guiding members extending radially; and a plurality of second guiding members arranged between the first guiding member and the ventilation holes and radially spaced apart from the first guiding member by a predetermined distance.

With the gap between the first guiding members and the second guiding members, the airflow guided by the air duct assembly is significantly improved compared to the conventional solutions, so that heat can be taken away more effectively, and thus the cooling effect is improved. Furthermore, by replacing a whole stripe as used in conventional solutions with a two-member design according to embodiments of the present disclosure, the material for making the airflow guides, such as copper, can be significantly reduced, so that an improved cooling effect can be obtained at low cost.

In some embodiments, the plurality of second guiding members are tilted, with respect to the corresponding first guiding members, at a predetermined angle in a rotating direction of the rotor radially outside to inside. In this way, the airflow guided by the air duct assembly can be further improved.

In some embodiments, the predetermined angle is in a range of 25°-60°. As a result, the airflow guided by the air duct assembly can be maintained at a high level, and thus the cooling effect is ensured.

In some embodiments, a number of the second guiding members is less than a number of the first guiding members. This arrangement can improve the cooling effect while further reducing costs.

In some embodiments, the number of the second guiding members is half of the number of the first guiding members.

In some embodiments, the base plate further comprises a plurality of fins aligned to fins of the core laminations, and wherein the plurality of first guiding members are arranged on the plurality of fins respectively, and the plurality of second guiding members are arranged between the plurality of fins and the ventilation hole. This arrangement can ensure that the airflow guided by the air duct assembly can be maintained at a high level.

In some embodiments, the plurality of first guiding members radially extend a predetermined length on the fins, and the predetermined length is above a half of a radial length of the fin. In this way, the airflow guided by the air duct assembly can be further improved with further lowered costs.

In some embodiments, the plurality of airflow guides are formed on the base plate (101) by welding. In this way, the air duct assembly can be manufactured in an easier way.

In some embodiments, the air duct assembly further comprises a plurality of secondary airflow guides arranged between the ventilation holes and each extending radially. This arrangement can ensure cooling air from the inlet channels to pass through the ventilation holes and the air duct assembly, to thereby ensure the smooth flow of the cooling air.

In a second aspect, a rotor is provided. The rotor comprises at least one air duct assembly as recited in the above first aspect.

In a third aspect, an electric machine is provided. The electric machine comprises a rotor as recited in the above second aspect.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent the same components.

FIG. 1 shows a side view of a rotor according to embodiments of the present disclosure;

FIG. 2 shows a front view of an air duct assembly in prior art;

FIG. 3 shows an enlarged view of portion A of an air duct assembly as shown in FIG. 2;

FIG. 4 shows a front view of an air duct assembly according to embodiments of the present disclosure;

FIG. 5 shows a side view of an air duct assembly according to embodiments of the present disclosure; and

FIG. 6 shows an enlarged view of portion C of an air duct assembly as shown in FIG. 4.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

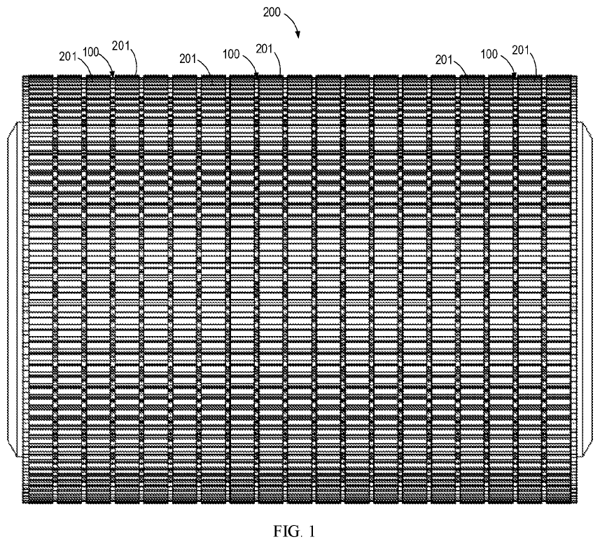

A rotor of an electric machine is shown in FIG. 1. As shown in FIG. 1, the rotor typically comprises a plurality of core laminations and air duct assemblies arranged between the core laminations. Core laminations, also known as laminated magnetic cores, are made of stacks of thin iron sheets coated with an insulating layer, lying as much as possible parallel with the lines of flux. The layers of insulation serve as a barrier to eddy currents, so eddy currents can only flow in narrow loops within the thickness of each single lamination.

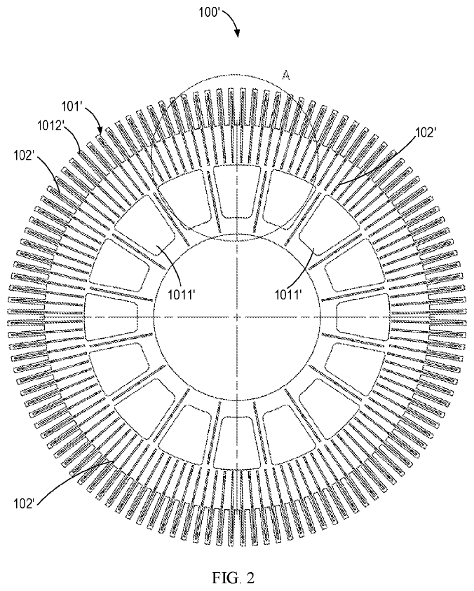

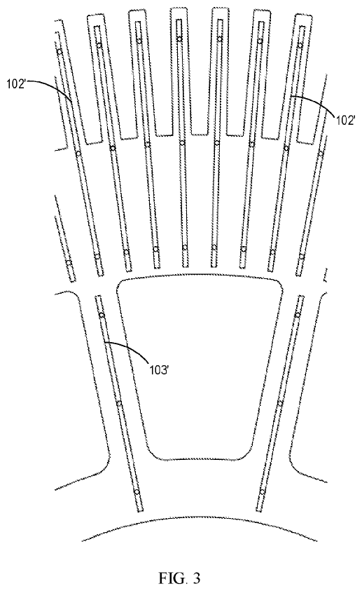

The air duct assemblies arranged between the core laminations in an axial direction to provide radial paths between the core laminations for radial airflow from inlet channels to outside of the rotor, to thereby cool the rotor. FIG. 2 shows a front view of a conventional air duct assembly and FIG. 3 shows an enlarged view of a portion of the air duct assembly in the circle A of FIG. 2.

As shown in FIGS. 2 and 3, the conventional air duct assembly typically comprises ventilation holes 1011′ which are axially aligned with inlet channels for cooling air to pass through. The conventional air duct assembly 100′ comprises a base plate 101′ and a plurality of fins 1012′ evenly formed on outer periphery of the base plate 101′. Between every two ventilation holes 1011′, there is an airflow guide, namely a secondary airflow guide, which axially protrudes from the base plate and mainly functions as a supporting element to maintain a distance between adjacent core laminations to thereby allow the air flow from the inlet channels through the ventilation hole. Besides the secondary airflow guides, the conventional air duct assembly 100′ further comprises a plurality of airflow guides, namely main airflow guides 102′, protruding axially from the base plate 101′ and distributed evenly in a circumferential direction. The plurality of airflow guides 102′, together with the base plate 101′ and the adjacent core laminations, form paths for airflow from the inlet channels.

Each of airflow guides 102′ is formed as one stripe extending radially. A portion of the stripe is arranged on the respective fin 1012′, as shown in FIGS. 2 and 3. The inventor has discovered through research that the airflow guide 102′ of the conventional air duct assembly 100′ with the structure and arrangement as shown in FIGS. 2 and 3 has a poor ability to transport airflow, which affects the cooling effect of the rotor.

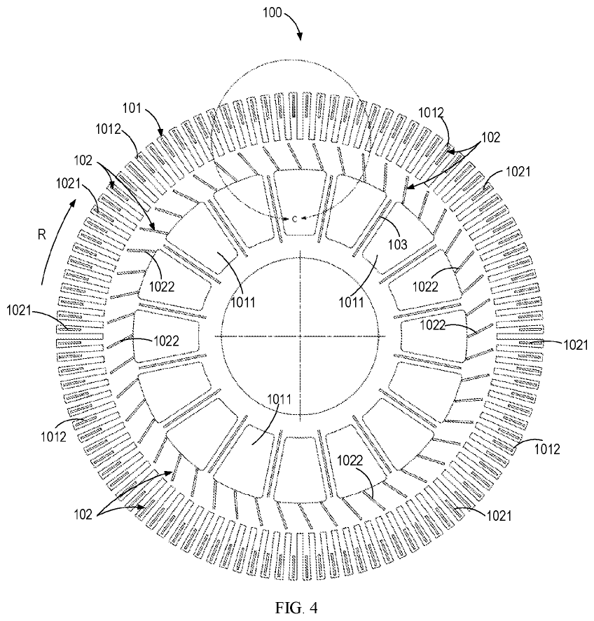

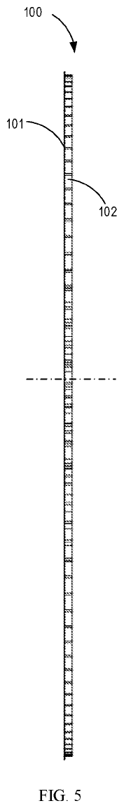

In order to at least partially address the above and other potential problems and at least to improve the cooling effect of the rotor, embodiments of the present disclosure provide an air duct assembly for a rotor of an electric machine. Now some example embodiments will be described with reference to FIGS. 4-6.

As shown in FIGS. 4-6, generally, the air duct assembly 100 according to embodiments of the present disclosure comprises a base plate 101 and a plurality of airflow guides 102 axially protruding from the base plate 101. The base plate 101 is provided with a plurality of ventilation holes 1011 arranged evenly in a circumferential direction. The ventilation holes 1011 are aligned with inlet channels of the rotor 200 to allow cooling air from the inlet channels to pass through. The cooling air may be circulated radially from the inlet channels to the outside of the rotor with rotation of the rotor 200 in some embodiments. In some alternative embodiments, the cooling air may also be forced to circulate by an air circulation device such as an electrical fan, which is arranged to provide axial airflow to the inlet channels. Besides the ventilation holes 1011, the base plate 101 may further comprise a plurality of fins 1012 which are aligned to fins of the core laminations 201 of the rotor 200 in some embodiments, as shown in FIG. 4.

The plurality of airflow guides 102 axially extend from a radial outer portion of an end surface of the base plate 101 relative to ventilation holes 1011, as shown in FIG. 4. The airflow guides 102 may axially extend the same distance from the end surface to thereby form paths for airflow together with the base plate 101 and an adjacent core lamination 201. In some embodiments, besides the airflow guides 102 arranged at a radial outer portion relative to ventilation holes 1011, the air duct assembly 100 may further comprise a plurality of secondary airflow guides 103 which mainly provide supporting between core laminations 201, to thereby allow the cooling air can enter the paths formed by the airflow guides 102, the base plate 101 and the adjacent core lamination 201.

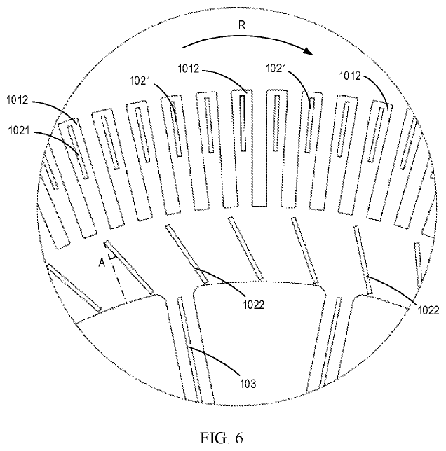

In comparison with the conventional solutions, each of the airflow guides 102 arranged at the radial outer portion relative to ventilation holes 1011 according to embodiments of the present disclosure adopts split two-section design. Specifically, the plurality of airflow guides 102 comprise a plurality of first guiding members 1021 and a plurality of second guiding members 1022, as shown in FIGS. 4 and 6.

The first guiding members 1021 each extend radially. For example, in some embodiments, each of the first guiding members 1021 may be arranged on a respective fin 1012 of the base plate 101 and extend radially. This arrangement may further facilitate the airflow to thereby improve the cooling effect of the air duct assembly 100.

The second guiding members 1022 are arranged between the first guiding members 1021 and the ventilation holes 1011 and radially spaced apart from the first guiding members 1021 by a predetermined distance, as shown in FIGS. 4 and 6. With the gap between the first guiding members 1021 and the second guiding members 1022, the airflow guided by the air duct assembly 100 is significantly improved compared to the conventional solutions, which has been discovered by the inventors through computational fluid dynamics (CFD) simulations. Accordingly, the amount of cooling air passing through the air duct assemblies 100 per second is significantly increased, so that heat can be taken away more effectively, and thus the cooling effect is improved.

Furthermore, by replacing a whole stripe as used in conventional solutions with a two-member design according to embodiments of the present disclosure, the material for making the airflow guides 102, such as copper, can be significantly reduced, so that an improved cooling effect can be obtained at low cost.

To further improve the cooling effect, in some embodiments, each of the second guiding members 1022 may be titled with respect to the corresponding first guiding member 1021. The corresponding first guiding member 1021 herein means the first guiding member 1021 whose radially inward extension can intersect with the second guiding member 1022 or is the closest to it. If in some embodiments there are multiple inward extensions of the multiple first guiding members 1021 intersect with the same second guiding member 1022, the first guiding member 1021 corresponding to the same second guiding member 1022 may be any of multiple first guiding members 1021 whose inward extensions intersect with the second guiding member 1022. For example, in some embodiments where there are multiple inward extensions of the multiple first guiding members 1021 intersect with the same second guiding member 1022, the corresponding first guiding member 1021 may be the one which is closest to an end of the second guiding member 1022 adjacent to the first guiding member 1021, or the one which is closest to a middle point of the second guiding member 1022. In some alternative embodiments, the corresponding first guiding member 1021 may also be a virtual radial line passing through either end or midpoint of the second guiding member 1022.

Furthermore, to obtain a further improved cooling effect, the titled direction of the second guiding member 1022 is associated with a rotating direction R of the rotor 200. For example, as shown in FIGS. 4 and 6, the rotating direction R of the rotor 200 is in a clockwise direction. In such a case, the second guiding member 1022 is titled, radially outside to inside, in the rotating direction R of the rotor 200, as shown in FIGS. 4 and 6. In this way, the airflow guided by the air duct assembly 100 can be further improved to thereby further improve the cooling effect.

The tilted angle may also be further set to a predetermined angle A to obtain a better cooling effect in some embodiments. For example, the inventors have discovered through research that the predetermined angle A may be set in a range of 25°-60° relative to the corresponding first guiding member 1021 to obtain an improved air flow. For example, in some embodiments, the predetermined angle A may be 45°. In this way, the amount of cooling air passing through the air duct assemblies 100 per second is more than double that of the conventional solutions, and thus the cooling effect is at least doubled in comparison to the conventional solutions.

In some embodiments, the number of the first guiding members 1021 and the number of the second guiding member 1022 may be different. For example, in some embodiments, the number of the second guiding members 1022 may be less than, e.g., half of the number of the first guiding member 1021. In this way, it can be discovered through the simulations that the air flow through the air duct assemblies 100 according to above embodiments of the present disclosure may be further improved. Furthermore, the material for making the airflow guides 102, such as copper, can be further reduced, so that an improved cooling effect can be obtained at further reduced cost.

It is to be understood that the above embodiments where the second guiding members 1022 is half of the number of the first guiding member 1021 are merely for illustrative purposes, without suggesting any limitation as to the scope of the present disclosure. Any appropriate ratio can be adopted between the numbers of the first guiding members 1021 and the second guiding members 1022. For example, in some embodiments, the number of the second guiding members 1022 may also be two-thirds, three-quarters, etc. of the number of the first guiding members 1021.

Furthermore, in some embodiments, the first guiding member 1021 may be arranged on the respective fin 1012 of the base plate 101. Correspondingly, the second guiding member 1022 may be arranged between the fins 1012 and the ventilation holes 1011, as shown in FIGS. 4 and 6. In this way, the arrangements of the first guiding members 1021 and the second guiding members 1022 can be more conducive to the air flow, to thereby improving the cooling effect.

Furthermore, in comparison with the convention solutions that the whole main airflow guide 102 radially extends along the full length and beyond the corresponding fin 1012 of the base plate 101, the first guiding member 1021 may radially extend a predetermined length on the respective fin 1012. For example, the predetermined length may be above, i.e., equal to or larger than a half of a radial length of the respective fin 1012 but smaller than the radial length of the fin 1012. For example, as shown in FIGS. 4 and 6, the first guiding member 1021 may extend in the outer half of the respective fin 1012 to obtain a better cooling effect.

It is to be understood that the above embodiments where first guiding member 1021 extends in the outer half of the respective fin 1012 are merely for illustrative purposes, without suggesting any limitation as to the scope of the present disclosure. Any appropriate arrangement of the first guiding member 1021 on the respective fin 1012 is also possible. For example, in some alternative embodiments, the first guiding member 1021 may also extend in the three-quarters of the respective fin 101.

Furthermore, in some alternative embodiments, the plurality of first guiding members 1021 may radially extend different lengths on the fins 1012. For example, a first group of the first guiding members 1021 may each extend radially in the outer half of the respective fin 1012, and a second group of the first guiding members 1021 may extend radially in the outer three-quarters of the respective fin 1012. The first group and the second group may be arranged alternatively. This arrangement can further improve the flexibility of the manufacturing of the air duct assembly 100.

In some embodiments, the airflow guides 102, i.e., the first guiding members 1021 and the second guiding members 1022 may be formed on the base plate 101 by welding. In this way, the manufacturing of the air duct assemblies 100 may be simplified, to thereby reduce the manufacturing cost.

According to other aspects of the present disclosure, a rotor 200 comprising at least one air duct assembly 100 as mentioned above is provided. With the air duct assembly 100 according to embodiments of the present disclosure, the rotor 200 can be cooled more effectively, thereby allowing the rotor 200 to rotate at a higher speed.

According to other aspects of the present disclosure, an electric machine comprising a rotor 200 as mentioned above is provided. With the air duct assembly 100 according to embodiments of the present disclosure, the electric machine can obtain an improved cooling performance, thereby allowing the electric machine may be operated at a higher power. In some embodiments, the electric machine may comprise an electric generator and/or an electric motor.

It should be appreciated that the above detailed embodiments of the present disclosure are only for exemplifying or explaining principles of the present disclosure and do not limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. An air duct assembly for a rotor of an electric machine, comprising:
a base plate arranged between core laminations of the rotor and comprising ventilation holes axially aligned with inlet channels of the rotor respectively; and
a plurality of airflow guides axially protruding from a radial outer portion of an end surface of the base plate relative to the ventilation hole, the plurality of airflow guides comprising:
a plurality of first guiding members extending radially; and
a plurality of second guiding members arranged between the first guiding member and the ventilation holes and radially spaced apart from the first guiding member by a predetermined distance.

2. The air duct assembly of claim 1, wherein the plurality of second guiding members are tilted, with respect to the corresponding first guiding members, at a predetermined angle in a rotating direction of the rotor radially outside to inside.

3. The air duct assembly of claim 2, wherein the predetermined angle is in a range of 25°-60°.

4. The air duct assembly of claim 1, wherein a number of the second guiding members is less than a number of the first guiding members.

5. The air duct assembly of claim 4, wherein the number of the second guiding members is half of the number of the first guiding members.

6. The air duct assembly of claim 1, wherein the base plate further comprises:
a plurality of fins aligned to fins of the core laminations, and
wherein the plurality of first guiding members are arranged on the plurality of fins respectively, and the plurality of second guiding members are arranged between the plurality of fins and the ventilation hole.

7. The air duct assembly of claim 5, wherein the plurality of first guiding members radially extend a predetermined length on the fins, and the predetermined length is above a half of a radial length of the fin.

8. The air duct assembly of claim 1, wherein the plurality of airflow guides are formed on the base plate by welding.

9. The air duct assembly of claim 1, further comprising:
a plurality of secondary airflow guides arranged between the ventilation holes and each extending radially.

10. A rotor comprising at least one air duct assembly of claim 1.

11. An electric machine comprising a rotor of claim 9.

12. The rotor of claim 10, wherein the plurality of second guiding members are tilted, with respect to the corresponding first guiding members, at a predetermined angle in a rotating direction of the rotor radially outside to inside.

13. The rotor of claim 12, wherein the predetermined angle is in a range of 25°-60°.

14. The rotor of claim 10, wherein a number of the second guiding members is less than a number of the first guiding members.

15. The rotor of claim 14, wherein the number of the second guiding members is half of the number of the first guiding members.

16. The rotor of claim 15, wherein the plurality of first guiding members radially extend a predetermined length on the fins, and the predetermined length is above a half of a radial length of the fin.

17. The rotor of claim 10, wherein the base plate further comprises:
a plurality of fins aligned to fins of the core laminations, and
wherein the plurality of first guiding members are arranged on the plurality of fins respectively, and the plurality of second guiding members are arranged between the plurality of fins and the ventilation hole.

18. The rotor of claim 10, wherein the plurality of airflow guides are formed on the base plate by welding.

19. The rotor of claim 10, wherein the air duct assembly further comprises:
a plurality of secondary airflow guides arranged between the ventilation holes and each extending radially.
